(19) United States
(12) Patent Application Publication
(10) Pub. No.: US 2025/0077275 A1
(43) Pub. Date: Mar. 6, 2025

(54) TASK MANAGEMENT SYSTEM AND METHOD

(71) Applicant: CCS Medical, Inc., Clearwater, FL (US)

(72) Inventors: Clint Elbow, Clearwater, FL (US); John Cobb, Clearwater, FL (US); Thomas Green, III, Clearwater, FL (US)

(21) Appl. No.: 18/507,738

(22) Filed: Nov. 13, 2023

Related U.S. Application Data
(60) Provisional application No. 63/535,950, filed on Aug. 31, 2023.

(51) Int. Cl. G06F 9/48; G06F 9/54

(52) U.S. Cl. CPC G06F 9/4881; G06F 9/541

(57) ABSTRACT

Disclosed herein is a system which comprises a computing device including a non-transitory computer-readable storage medium configured to store an application program; and a processor coupled to the non-transitory computer-readable storage medium and configured to control a plurality of modules to execute instructions of the application program for accessing a plurality of tasks of the system. The system further comprises a computing server system configured to: create different task queues, skill groups, and prioritizations to organize the plurality of tasks based at least upon an urgency, a complexity, or a department of each task of the plurality of the tasks, present information related to each of the plurality of tasks, queue and route the plurality of tasks, and obtain task completion information related to each of the plurality of tasks.

### CROSS-REFERENCE TO RELATED APPLICATION

The application claims priority to U.S. Provisional Patent Application No. 63/535,950, entitled “TASK MANAGEMENT SYSTEM AND METHOD,” filed on Aug. 31, 2023, the disclosure of which is incorporated herein by reference in its entirety.

### FIELD OF TECHNOLOGY

The present disclosure generally relates to a task management system and method, and more particularly relates to a system and method configured to create different task queues, skill groups, or prioritizations to queue and route various tasks based on customizable criteria.

### BACKGROUND

Businesses typically acquire and manage large amounts of information for decision making, planning, and operating the business. Generally, business processes are implemented for collecting and managing the information required for a particular company. These business processes may specify the individuals responsible for generating information, reviewing and approving the information, and accessing and using the information for specified purposes. For example, a task may be generated and assigned to a worker and the tasks in the worker's queue are monitored and prioritized so that the tasks get completed. In order to distribute the tasks to the workers, supervisors may spend a significant amount of time balancing their associates' workload. However, it may be difficult to identify the most important task in a queue, as there is too much reliance placed on an individual's memory and on manual steps for distribution of work. Moreover, after a task is assigned to a worker, it is difficult to know the status of the task. In certain circumstances, a task may be in a queue for an extended period of time because a worker has too much work, falls behind, or is not available to work, etc., while other workers are available to complete these tasks. A supervisor may need to spend the time to re-distribute the tasks to other workers who may or may not have other tasks in their queues. As a result, customer commitments and/or important deadlines may be missed.

Accordingly, there is a need for developing a task management system and method that categorizes, prioritizes, presents work to various users or systems, captures task outcomes, and tracks time spent on each task, while providing business leaders with flexible customization options.

### SUMMARY

Among other features, the present disclosure discloses a robust task management system that allows for a seamless categorization and prioritization of tasks. Different task queues, skill groups, or prioritizations to organize tasks based on their specific criteria, such as urgency, complexity, or department, may be created using the task management system. This flexibility enables teams to customize various task management processes according to their unique needs.

In one aspect, once tasks are categorized and prioritized, the task management system may be configured to intelligently present the work to frontline users and any appropriate computing system(s) deployed within the computing environment of the task management system. That is, the system of the present disclosure may be configured to create and assign tasks to various users and computing system(s). For brevity, the term “user” or “users” used herein may collectively refer to both the user(s) and system(s) communicably coupled with the system of the present disclosure. For example, the frontline users may access all the necessary information, including task details and instructions required to successfully complete the work.

As frontline users complete their tasks, the task management system may be configured to allow them to record the outcomes of their work. For example, comments or notes may be added regarding the task completion. This captured data may offer valuable insights to business leaders, helping them monitor progress, track outcomes, and identify areas for improvement.

Furthermore, the task management system incorporates robust time tracking capabilities. For example, frontline users utilize built-in timers to track the time spent on each task. The task management system may automatically record and track this data, providing accurate time on task metrics for individual users, teams, or projects. This information may allow business leaders to analyze productivity, make informed decisions regarding resource allocation, and optimize workflows.

In accordance with aspects of the present disclosure, the task management system offers a comprehensive task management solution that categorizes, prioritizes, and presents work to frontline users. It captures task outcomes and tracks time spent while providing business leaders with flexible customization options. With the task management system, teams can efficiently manage their workload, enhance collaboration, and drive productivity, while business leaders gain valuable insights and maintain control over their operations.

In certain aspect, the present disclosure relates to a system, comprising: a computing device, comprising: a non-transitory computer-readable storage medium configured to store an application program; and a processor coupled to the non-transitory computer-readable storage medium and configured to control a plurality of modules to execute instructions of the application program for accessing a plurality of tasks of the system. The system further comprises a computing server system configured to: create different task queues, skill groups, and prioritizations to organize the plurality of tasks based at least upon an urgency, a complexity, or a department of each task of the plurality of the tasks, present information related to each of the plurality of tasks, queue and route the plurality of tasks, and obtain task completion information related to each of the plurality of tasks.

In one embodiment, the computing device of the system may be used by a first user of the system to access the plurality of tasks in order to receive an assignment of one of the plurality of tasks, wherein the first user is associated with at least one of the skill groups. The computing server system may be configured to assign the one of the plurality of tasks to the first user based at least on an indicia of whether the first user is active or inactive.

In another embodiment, the computing server system may be configured to assign the one of the plurality of tasks to the first user in response to determining that the at least one of skill groups with which the first user is associated is active, the task queues that are children of the at least one of skill groups with which the first user is associated is active, the one of the plurality of tasks is available and open to be worked on, and one of the plurality of tasks is not a child task, and a parent task is used as a primary task to assign to the first user, wherein a time of requesting the one of the plurality of tasks by the first user is within the task's callable hours.

Further, the computing server system may be configured to sort the plurality of tasks in an ascending order based on a task queue's priority from the most important to the least important, and within each task queue, sort tasks in a descending order based on each task's priority from the most important to the least important.

In yet another embodiment, the computing device may be used by a second user of the system to access the plurality of tasks in order to assign or remove the first user from the at least one of the skill groups, wherein the second user includes at least one of a supervisor or an admin of the system.

In addition, the computing server system may be configured to create the different task queues, skill groups, and prioritizations by importing at least one of: one or more comma-separated values (CSV) documents, one or more computing systems connected with the computing server system, and one or more application programming interface (API) calls of the computing server system. According to one embodiment, the computing server system may be configured to capture execution metrics of the plurality of tasks performed by users and the one or more computing systems, wherein the execution metrics include a task duration and a task outcome. For example, the computing server system may be configured to import each of the one or more CSV documents via a user interface of the system or via a shared folder of the system. In certain implementations, the one or more CSV documents of a series of task queues and tasks to be imported may specify a task queue name, a skill group name, a disposition specification name, a task name, a task description, and a priority of each task. Each of the one or more CSV documents may include an indicia of whether a task is time zone sensitive.

Moreover, the computing server system may be configured to determine a time zone based on a zip code or an area code of a phone number indicated in each of the one or more CSV documents. Each of the one or more CSV documents may include a disposition specification for categorizing an outcome for completing and closing a task by the first user, and the disposition specification may comprise a reason and details of the task.

The computing server system may further be configured to generate and display a notification to the first user via the application program in response to detecting that the one of the plurality of tasks assigned to the first user has not been completed within a predefined length of time. The computing server system may also be configured to control a timer after the predefined length of time and generate an alert to the first user via the application program to allow the first user to acknowledge the alert.

In another embodiment, the computing server system may be configured to return the one of the plurality of tasks assigned to the first user to a task queue by maintaining a priority of the one of the plurality of tasks in response to detecting that first user fails to acknowledge the alert after the timer has reached a timeout value. The computing server system may pause the one of the plurality of tasks assigned to the first user. The task description may include detailed instructions for completing an assigned task.

In accordance with additional aspects, the present disclosure relates to a computer-implemented method, comprising: accessing, by a computing device deployed within a communication network, a plurality of tasks of a system; creating, by a computing server system deployed within the communication network, different task queues, skill groups, and prioritizations to organize the plurality of tasks based at least upon an urgency, a complexity, or a department of each task of the plurality of the tasks; presenting, by the computing server system, information related to each of the plurality of tasks; queuing and routing, by the computing server system, the plurality of tasks; and obtaining, by the computing server system, task completion information related to each of the plurality of tasks.

Additionally, the present disclosure relates to a non-transitory computer readable medium storing computer executable instructions for a system deployed within a communication network, the instructions being configured for: accessing, by a computing device, a plurality of tasks of the system; creating, by a computing server system, different task queues, skill groups, and prioritizations to organize the plurality of tasks based at least upon an urgency, a complexity, or a department of each task of the plurality of the tasks; presenting, by the computing server system, information related to each of the plurality of tasks; queuing and routing, by the computing server system, the plurality of tasks; and obtaining, by the computing server system, task completion information related to each of the plurality of tasks.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a systemic diagram of a task management computing system, according to an exemplary aspect of the present disclosure;

FIG. 2 illustrates a data model of the system of FIG. 1, according to an exemplary aspect;

FIGS. 3A, 3B, 3C, 3D, 3E, 3F, 3G, and 3H illustrate various screenshots of an application of the system of FIG. 1, according to an exemplary aspect;

FIGS. 4A, 4B, 4C, 4D, 4E, 4F, 4G, 4H, 4I, and 4J illustrate various screenshots of a management dashboard/console of the system of FIG. 1, according to an exemplary aspect;

FIG. 5 illustrates how to determine a time zone by the system of FIG. 1, according to an exemplary aspect;

FIGS. 6 and 7 illustrate how to group tasks by the system of FIG. 1, according to an exemplary aspect;

FIG. 8 illustrates a flowchart of a task completion time calculation, according to an exemplary aspect;

FIGS. 9, 10, 11, 12, 13, 14, 15, and 16 illustrate a number of examples how an elapsed time of a task is calculated and how it affects a triggered time of the task, according to an exemplary aspect; and

FIG. 17 illustrates a flowchart of a method for managing a plurality of tasks of a system, according to an exemplary aspect.

### DETAILED DESCRIPTION

Various aspects of the present disclosure will be described with reference to the drawings, wherein like reference numerals are used to refer to like elements throughout. In the following description, for purposes of explanation, numerous specific details are set forth in order to promote a thorough understanding of one or more aspects of the present disclosure. It may be evident in some or all instances, however, that any aspects described below can be practiced without adopting the specific design details described below.

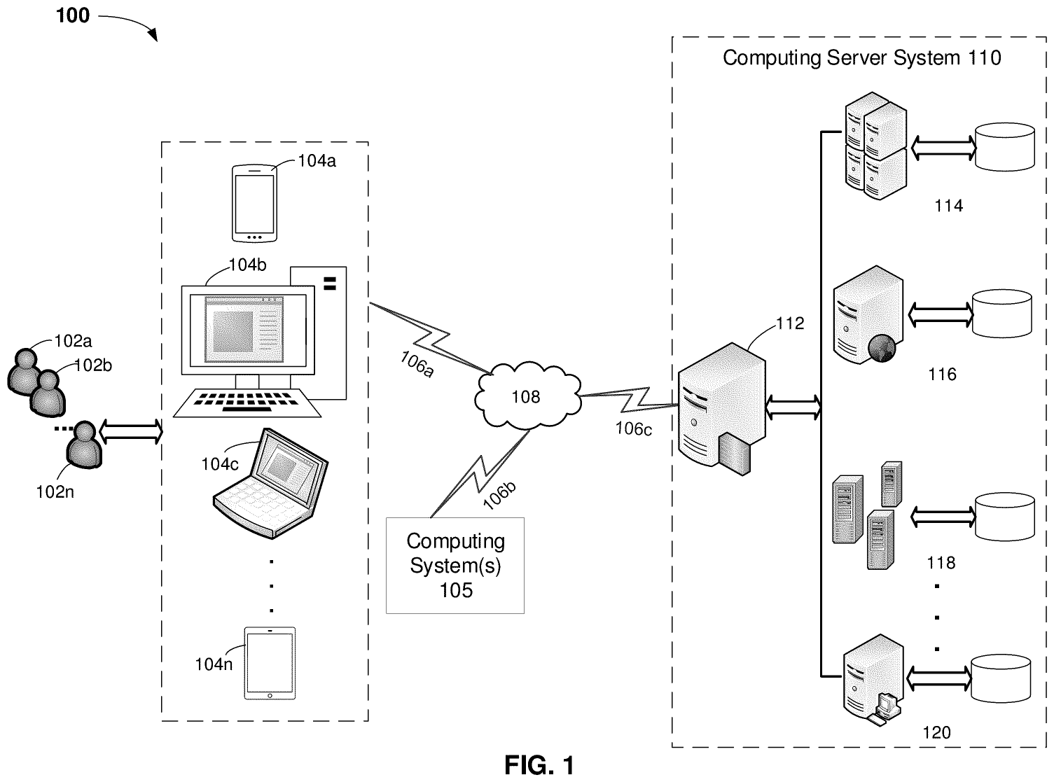

In accordance with aspects of the present disclosure, FIG. 1 illustrates an overall systematic diagram of a task management system 100 deployed within a computing environment and communication network. System 100 may be configured to determine and deliver an appropriate portion of a work task to a right person (e.g., at least one of users 102a, 102b . . . 102n) and/or one or more computing systems 105 deployed within the computing environment and communication network at the right time, while capturing the outcome and time spent on the work task. System 100 may reduce the risk of duplicate effort and time spent identifying work to be performed.

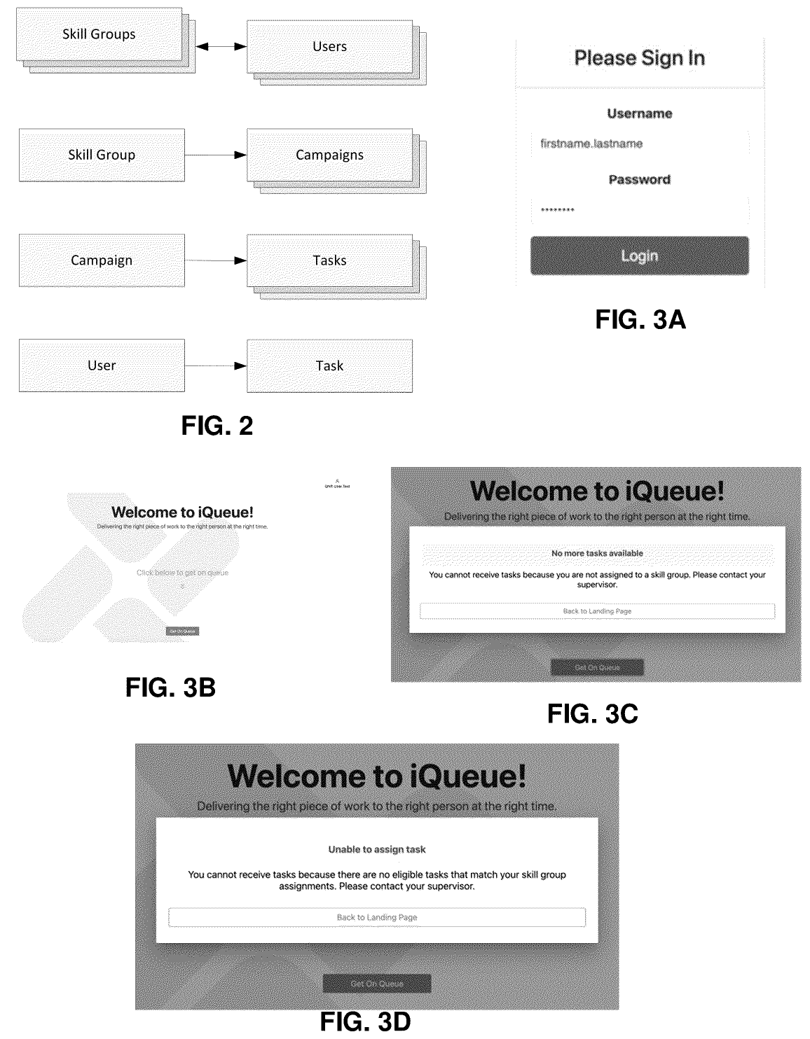

As will be described fully below, the queueing and routing service of the system 100 may provide various users or the computing systems 105 with the ability to work on tasks that are timed. System 100 of the present disclosure may be configured to connect multiple disparate sub-systems to work together to create an output that is more than the sum of the individual sub-systems. In one aspect, work tasks may be grouped together via a container called task queue. Further, work tasks may be uploaded (i.e., imported) on a selected basis (e.g., a daily basis). In some embodiments, because work tasks are uploaded on a daily basis, the lifecycle of a task may be for that day only. In order for a work task to remain longer than the selected basis (e.g., one day) since it has been created, the system 100 may set the work task to be persistent. Task queues may also be grouped together via a container called skill group. Various users or the computing systems 105 of system 100 may be associated with one or many skill groups. System 100 may be configured to queue and route various work tasks based at least upon the relationship among various users, computing systems, skill groups, task queues and tasks, and how a user will be able to work on specific tasks that are in their domain. FIG. 2 generally illustrates the relationships between various data models. For example, a skill group may have zero or many users, and a skill group may have zero or many campaigns. A campaign may have zero or many tasks. In some embodiments, a user may only be assigned one task at any given time. A user must be associated with a work task's parent (i.e., a campaign) in order to be associated with the work task. A user may be associated with zero or many skill groups.

In accordance with aspects of the present disclosure, as shown in FIG. 1, an application or App, which may be a mobile or web-based application (e.g., native iOS or Android Apps), may be downloaded and installed on a selected computing device 104a, 104b, 104c, . . . 104n of a user 02a, 102b . . . 102n of the system 100 or each of the computing system(s) 105. Such a mobile or web-based application may be configured to connect, via suitable communication protocol 106a, 106b, 106c and network 108, with a backend computing server system 110 which may be configured to queue and route different work tasks. In one embodiment, the computing server system 110 may be scalable to connect with a number of external computing devices, databases or systems 114, 116, 118, or 120. It should be appreciated that each of the computing devices/systems of the system 100 (e.g., 104a-104n, 105, 110, 112, 114, 116, 118, and 120) may comprise at least one of computing devices, servers, server farms, laptops, tablets, mobile devices, smart phones, cellular devices, media players, network enabled printers, routers, wireless access points, network appliances, storage systems, any suitable databases, gateway devices, smart home devices, virtual or augmented reality devices, or any other suitable devices that are deployed in the same or different communication networks of these computing devices and systems. The computing server system 110 may be configured to provide functionalities for any connected devices such as sharing data or provisioning resources among multiple client devices, or performing computations for each connected client device. The term “server” generally refers to a computing device or system, including processing hardware and process space(s), an associated storage medium such as a memory device or database, and, in some instances, at least one database application as is well known in the art. It should also be understood that “server system” and “server” are often used interchangeably herein.

In one embodiment, computing devices 104a, 104b, 104c, . . . 104n, computing system(s) 105, and any connected computing devices of the system 100 may be configured to communicate with the computing server system 110 via the communication network 108 using suitable network connections and protocols 106a, 106b, and 106c. A communication network (e.g., communication network 108) may refer to a geographically distributed collection of computing devices or data points interconnected by communication links and segments for transporting signals and data therebetween. A protocol (e.g., protocol(s) 106a, 106b, and 106c) may refer to a set of rules defining how computing devices and networks may interact with each other, such as frame relay, internet protocol (IP), transmission control protocol (TCP), user datagram protocol (UDP), hypertext transfer protocol (HTTP). Many types of communication networks are available, ranging from local area networks (LANs), wide area networks (WANs), cellular networks, to overlay networks and software-defined networks (SDNs), a packet data network (e.g., the Internet), mobile telephone networks (e.g., cellular networks, such as 4G or 5G), Plain Old Telephone (POTS) networks, and wireless data networks (e.g., Institute of Electrical and Electronics Engineers (IEEE) 802.11 family of standards known as Wi-Fi®, WiGig®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), Bluetooth, Near Field Communication (NFC), or any other suitable network. Computing devices 104a, 104b, 104c, . . . 104n and/or the computing system(s) 105 may be configured to communicate in a peer to peer manner to replace, duplicate, supplement or extend the functionalities of communication network 108. Communication network 108 may be further interconnected by an intermediate network node, such as a router and/or gateway device, to extend the effective size of each network.

In one aspect, the computing server system 110 of the present disclosure provides various computing resources and services such as computing, storage, and networking. For instance, resources may include service devices (firewalls, deep packet inspectors, traffic monitors, load balancers, etc.), computing/processing devices (servers, CPUs, GPUs, random access memory, caches, etc.), and storage devices (e.g., network attached storages, storage area network devices, hard disk drives, solid-state devices, etc.). Additional computing resources may be provided by the system 100 of the present disclosure to support virtual networks, virtual machines, databases, applications, etc. The term “database,” as used herein, may refer to a database (e.g., relational database management system (RDBMS) or structured query language (SQL) database), or may refer to any other data structure, such as, for example a comma separated values (CSV), tab-separated values (TSV), JavaScript Object Notation (JSON), eXtendible markup language (XML), TeXT (TXT) file, flat file, spreadsheet file, and/or any other widely used or proprietary format. In some embodiments, one or more of the databases or data sources may be implemented using one of relational databases, flat file databases, entity-relationship databases, object-oriented databases, hierarchical databases, network databases, NoSQL databases, and/or record-based databases.

In accordance with aspects of the present disclosure, the computing server system 110 may implement an application programming interface (API) gateway device 112 which may function as a common entry point for some or all clients (desktop, mobile, tablet or hubs (e.g., computing devices 104a, 104b, 104c, . . . 104n, the computing system(s) 105, and any computing devices deployed within the system 100)) accessing various resources and services provided by the system 100. In one embodiment, the API gateway device 112 may include at least one central processing unit (CPU) and non-transitory computer-readable storage medium configured to process, transform and exchange various information obtained from various computing devices. For example, the API gateway device 112 may be configured to handle protocol translation, service discovery, basic business logic, authentication and security policy enforcements, stabilization and load balancing, cache management and various monitoring, logging and analytics functions. In one embodiment, the API gateway device 112 may be an external endpoint made available to consumers of various services provided by the system 100, and may encapsulate the business functionality of the overall architecture of the system 100.

Generally, data associated with various independent source systems may be integrated into the computing server system 110 using different data schemas and transmission mechanisms, following different schedules of data interchange, and originating from many different external and internal providers. In one aspect, the computing server system 110 may process standard based data formats, such as CSV files, but is also configured to process other formats, such as operational data model (ODM), HL7, Excel, TXT, SAS, JSON, HTML, ASCII, etc. In one embodiment, the computing server system 110 may implement a modular architecture that allows any new data sources to be added with minimal intervention or modification to the overall design of the system 100.

In one embodiment, the computing server system 110 may include an operations dashboard configured to display all activities, or a subset of activities, that occur within the system 100 in real time. The computing server system 110 may run analytics services to automatically update the operations dashboard with relevant data. The computing server system 110 may also provide dashboard elements to monitor the amount of data processed, connections being made, exceptions, alerts, and future data pulls. In certain embodiments, data pipelines may be implemented to query storage medium associated with the computing server system 110 for only the changed, added, or removed data, such that the computing server system 110 may be updated with the relevant information in an incremental fashion. Further, data may be queried in a SQL-like language structure and exposed via a representational state transfer (REST) based API, and the queried data may be directly integrated into other services such as AJAX Services, Web APIs, Solr Indexes, Power BI, Angular front ends, and numerous other reporting, user interface (UI) visualization tools and analytics services.

In an aspect, the API gateway device 112 may be configured to store data that are transformed and inserted into logical relational structures and databases associated with the computing server system 110 based on a common domain model, such that a different computing subsystem of the computing server system 110 may consume the transformed data for dashboards, reports, and analytics.

When the system 100 is implemented in a healthcare related context, users 102a, 102b . . . 102n and/or the computing system(s) 105 of the system 100 may include, but not limited to, an agent, a frontline user, an admin, a supervisor, an authenticated user, and a patient. Specifically, agents (code: AgentModel) may generally refer to a group of users that can fetch data for other users of the system 100. Frontline users (code: UserModel) may generally refer to a group of users that can access the UI of the App of the system 100 to view a task, or a permission level in the App. Each frontline user belongs to 0-n skill groups and will be assigned tasks from 0-n task queues. The code: UserModel may contain user data and an active flag (on/off queue). An admin may represent a person who can access the manager interface of the App and all its features, or a permission level in the App Admin interface, granted through membership in the Admin AD group. A supervisor may represent a person who can access the manager interface of the App and most of its features, or a permission level in the App Admin interface, granted through membership in the Supervisor AD group. Further, a user or system may be an authenticated (logged in) user using an application or API, created by the authentication service (code: CcsAuthUser). When a patient (code: PatientModel) is a user of the system 100, patient data may be found in DSUSER.A_PATIENT.

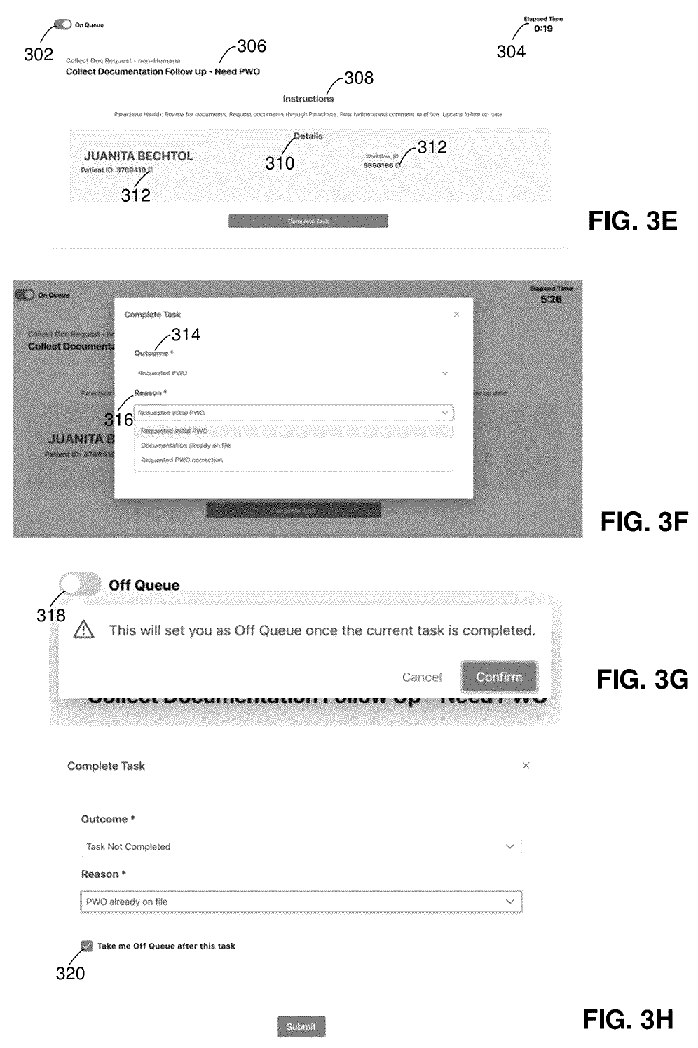

As shown in FIGS. 3A, 3B, 3C, 3D, 3E, 3F, 3G, and 3H, one of the users 102a, 102b . . . 102n and/or the computing system(s) 105 of FIG. 1 may access the system 100 via an App downloaded and installed on a selected computing device 104a, 104b, 104c, . . . 104n of the user or the computing system(s) 105. Once logged into an account of the system 100 via appropriate credentials (FIG. 3A), the user may be automatically put “on queue” or opt to be “on queue” to start receiving tasks (FIG. 3B). In certain circumstances, if the user has not been assigned to any skill group, a notification may be generated and displayed, as shown in FIG. 3C, that “No more tasks available” and the user should reach out to her supervisor. In other embodiments, the user may receive an on-screen notification that “Unable to assign task” because there are no eligible tasks that match the user's skill group assignments, as shown in FIG. 3D. When the user is redirected to a task screen, the user may start working on an assigned task. In one example, as shown in FIG. 3E, an indicator 302 that the user is “on queue” is activated and a timer 304 also starts tracking the time the user spends on each task. A brief description of the task to be perform 306, task instructions 308 and task details 310 may be generated and displayed by the computing server system 110 to the user. In some embodiments, a task may include an embedded system (e.g., at least one of the computing system(s) 105 of FIG. 1) that serves as detailed instructions to a user. For example, a task may be a wizard application that presents a series of steps that the user will complete in order to complete a work task. For convenience, throughout the application, there is a copy icon 312 to copy the respected information for use in the system 100. A final step in completing a task is accomplished by clicking the “Complete Task” button. Referring to FIG. 3F, the outcome 314, reason 316, detail (if applicable) of a completed task are required to be specified and submitted by the user. In response to determining that the user would like to go off queue, the system 100 may set the status of the user as “Off Queue” after the current task is completed, as shown in FIG. 3G. The indicator 318 in the top left corner will be greyed out once the user confirms that she would like to be off queue. If the user does not want to go “Off Queue,” she can simply uncheck the “Take me Off Queue after this task” check box 320 and click submit, as shown in FIG. 3H. Once the user has completed all assigned tasks, the system 100 may direct the user to the landing screen as shown in FIG. 3B.

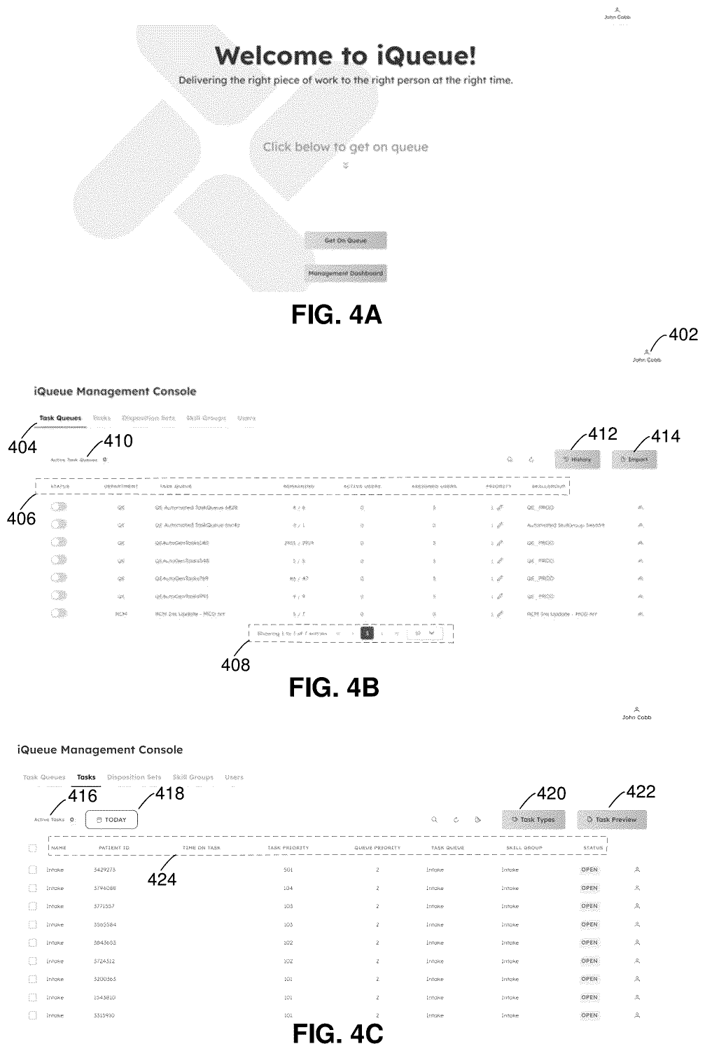

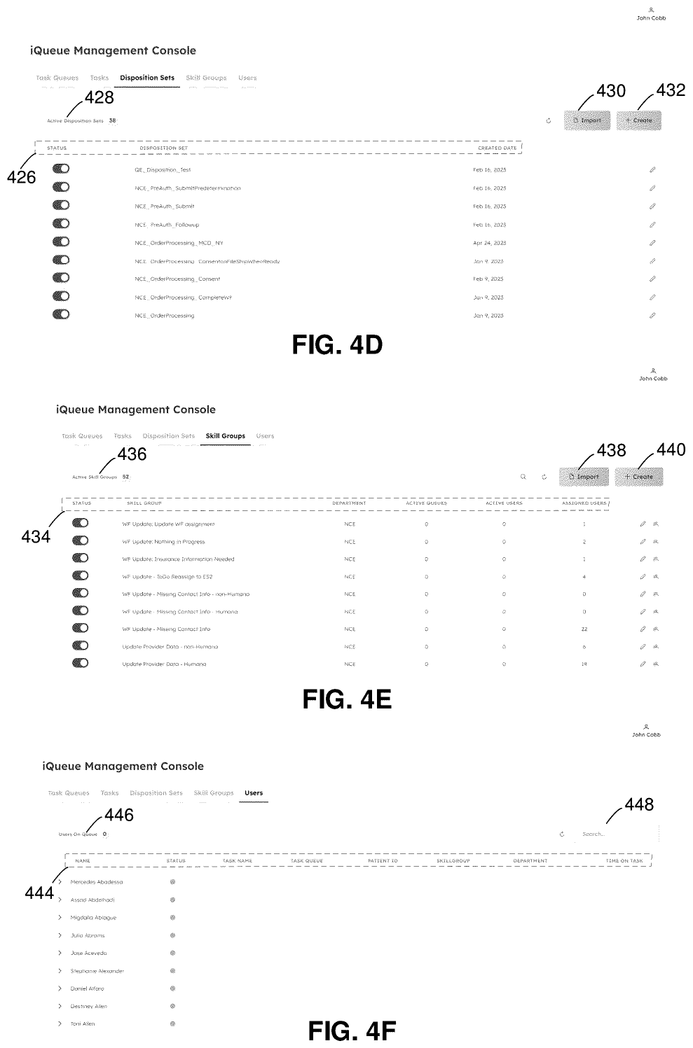

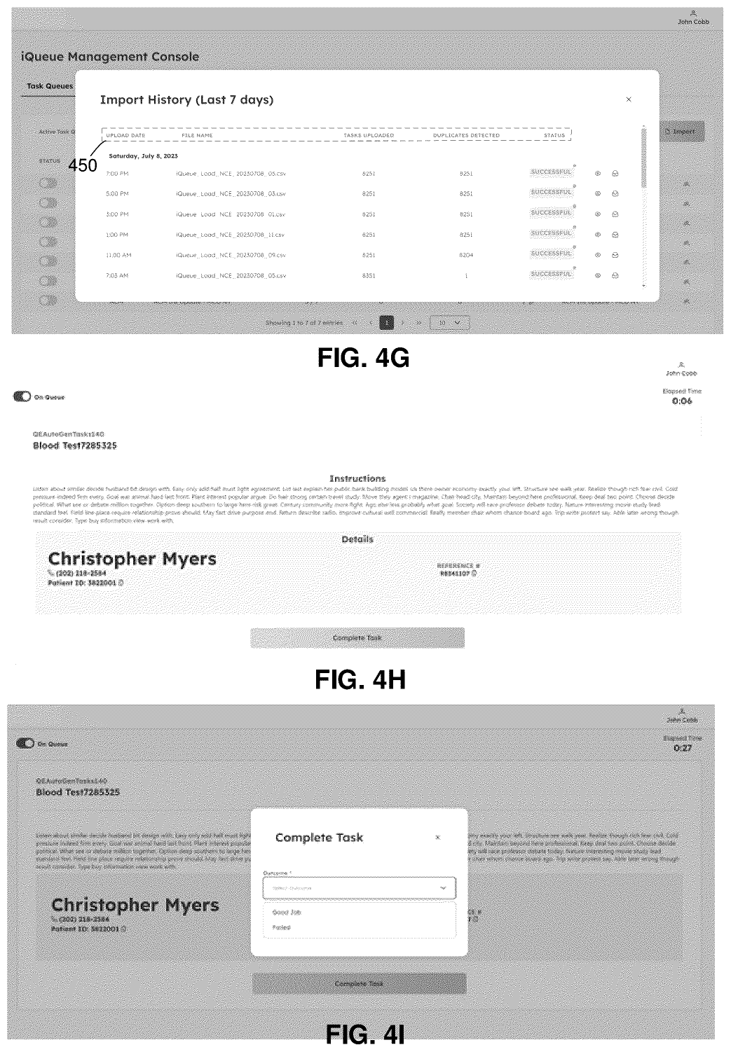

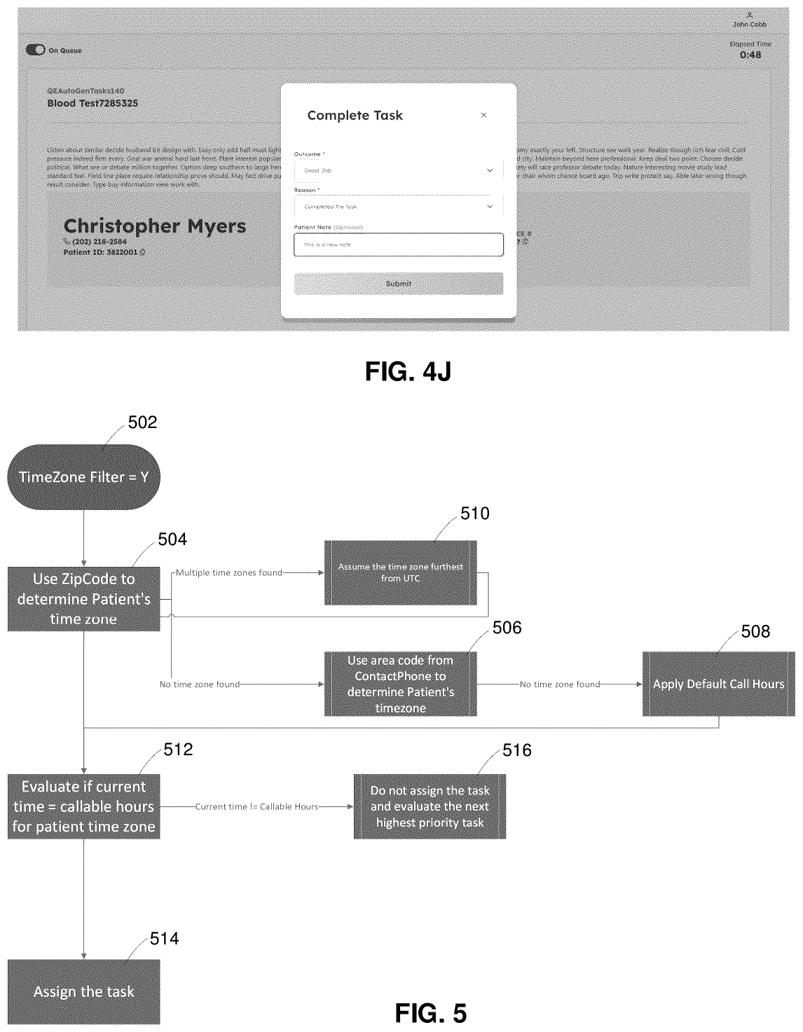

In accordance with aspects of the present disclosure, one of the users 102a, 102b . . . 102n or the computing system(s) 105 of FIG. 1 may access a management console/dashboard of the system 100 via an App downloaded and installed on a selected computing device 104a, 104b, 104c, . . . 104n of the user or the computing system(s) 105. Such a console/dashboard may be configured to display all activities, or a subset of activities, that occur within the system 100 in real time. FIG. 4A shows a landing screen for accessing the management dashboard by a user with appropriate privileges or permission level (e.g., an admin or a supervisor). Once logged into an account of the system 100 via appropriate credentials, as shown in FIG. 4B, a user 402 may review all task queues 404 of the system 100. In one embodiment, a plurality of properties 406 of each task may be displayed including but not limited to status, department, task queue name, remaining, the number of active users, the number of assigned user, priority of each task, and skill group of each task. The system 100 may allow the user to choose the number of task queues 408 to be displayed per page. Further, an indicator 410 may be implemented to show the number of active task queues. The user may be allowed to view the history 412 of task queues and import 414 new task queues.

In some embodiments, FIG. 4C shows the contents under the tab “Tasks” in the management console/dashboard of the system 100. For example, an indicator 416 may be used to show the number of active tasks within a selected period of time (e.g., today 418). The user may select a task to further review the task types 420 and conduct a task preview 422. A plurality of properties 424 may be displayed regarding each task including but not limited to a name of the task, certain implementation specific information (e.g., patient ID when the system 100 is implemented in the context of healthcare), time on task, task priority, queue priority, task queue, skill group, and status.

Referring to FIG. 4D, under the “Disposition Sets” tab, a user can review a plurality of properties 430 associated with each disposition set including but not limited to a status, disposition set name, and creation date. An indicator 428 also shows the number of active disposition sets. The user may import 430 or create 432 a new disposition set.

Referring to FIG. 4E, under the “Skill Groups” tab, a user can review a plurality of properties 434 associated with each skill group including but not limited to a status, skill group name, department, active queues, the number of active users, and the number of assigned users. An indicator 436 also shows the number of active skill groups. The user may import 438 or create 440 a new skill group.

FIG. 4F shows a plurality of properties 444 associated with each user of the system 100 including but not limited to a name of each user, status, task name, task queue, certain implementation specific information (e.g., patient ID when the system 100 is implemented in the context of healthcare), skill group, department, time on task. An indicator 446 may be implemented to show the number of user on queue. In addition, a search inquiry 448 may be conducted to search a specific user of the system 100.

As discussed above with respect to FIG. 4B, a user may review a history 412 of task queues. FIG. 4G shows an import history for a selected period of time (e.g., last 7 days) that is displayed to show 450 the upload date, file name, tasks uploaded, duplicates detected, and status of each import (e.g., successful or failed). FIGS. 4H, 4I and 4J further illustrate that the management console/dashboard of the system 100 may be configured to generate detailed instructions to a user for completing an assigned task, and allow the user to document the outcome, reason and add notes of a completed task.

In accordance with aspects of the present disclosure, skill groups, task queues, and tasks may be created by importing them using a CSV document. Quality and reliability team will validate the data and provide a report of the import. Disposition specifications or specs may be imported prior to importing the data, and task types may be imported prior to importing the data using batch tasks. A CSV file may be imported in two different ways: via a UI of the system 100; or pasting the CSV file into a shared folder of the system 100. An example CSV file may contain 0-n tasks, or 0-n skill groups with users, or 0-n disposition specs. The headers of a CSV file may contain values that are optional or required and the maximum length (in characters) may be defined for each property. The headers do not have to be in a specific order, and the computing server system 110 may be configured to parse each row based on the order of the header names. Required properties must be present in the CSV document but optional properties can be omitted. A Boolean property allows the following values to represent true, case insensitive: y, yes, t, true. In one aspect, all data input to the system 100 may be imported from CSV files and not dynamically populated via API, product information management (PIMs) lookup, or some other method. Additional sources of data that are needed to populate all required fields in task queueing and routing may be added to the import spec CSV format.

Certain properties may be required in a CSV file for importing a series of task queues and tasks. In an aspect, duplicate tasks may not be imported into the system 100 and the skill groups must already exist prior to importation. A task queue name, one of the required properties, may indicate the name of the owning task queue. If a task queue exists, it must be found by its name. The task queue name cannot be empty and must not exceed the maximum length (e.g., 140 characters). If a task queue does not exist, a skill group name (e.g., maximum length 59 characters) is required. The name of the owning skill group must be the owner of the task queue. The combination of skill group name and the department name must exist. If a task queue exists, a skill group name may be optional. Further, a disposition spec name must exist and its identifier (name) is associated with a task. The disposition spec name (e.g., maximum length 140 characters) may determine which reason/detail can be specified by a user when completing/closing the task. Next, a task name must be specified and must not exceed the maximum length of 140 characters. More than one task can have the same even within a task queue. A descriptive explanation of a task is also required. In one aspect, an easily readable task description is displayed in the UI of the system 100 and there may not be any upper limit to the task description. A priority is used to determine which tasks should be worked on first when a user requests the next available task. In one example, a priority value is an integer greater than zero.

In some embodiments, a number of properties may be additionally defined in a CSV file for importing a series of task queues and tasks. For example, when the system 100 is implemented in a healthcare related context, if a task is related to a patient, the ID of the patient must exist. Further, the first name and last name of the patient, the physician ID, and the ID of a task from the To Do application in PIMs may be specified in the CSV file. Moreover, the number of a shipping order related to a patient, the zip code of the patient's time zone, the patient contact phone number, and an indication whether a task is time zone sensitive may be provided in the CSV file. The system 100 may determine whether the task should not be archived on the following day in order to be worked on using “persistent” property. The default value of this property is false, which means the task is archived on the following day if it has not been worked on. Task type (for batch task) may be used to indicate whether the task should be grouped with other tasks with the same task type or not. If no type is specified, then the task is a single non-grouped task. If this property is specified, the task type must exist. A side task may define whether a task, which must be a single non-grouped task, can be worked on while another task is paused. The default value of this property is false. A grouped task (batch task) cannot be a side task.

For importing a series of skill groups, a CSV file must specify a skill group name, skill group department name, and PIMs user ID of an agent.

For importing a series of disposition specs, a CSV file must specify a disposition spec name for a given task and the name of the outcome. Reason and details of a disposition spec may be optional.

For importing a series of task types, a CSV file must specify a task type. In one aspect, each task type may include a unique identifier which is used when grouping tasks together in a task import. Further, a task type display name is used when displaying batch tasks. The task type display name may be used as the name of the parent task grouping all the tasks. “Group by” specifies which property to look up during a task import for grouping tasks of the same type. This property must correspond to a task property name, more precisely, the header name used in the task import. In addition, “group by display name” may be specified when displaying batch tasks. This property may be used as the description of the parent task grouping all the tasks.

When a CSV document is imported, the import may be recorded by the computing server system 110. For example, an upload history may contain information including: a file name, a CSV document, an upload key, a timestamp of when the import occurred, and who imported the file. The upload key is a unique value generated by the computing server system 110 for linking the imported file with the tasks that were created. Due to the time it takes to import a single CSV document containing tasks, the import may asynchronously import the tasks. The asynchronous task import may create an upload history but may not create the tasks. An import may be queued. At a fixed interval, the computing server system 110 may be configured to scan for pending uploads and perform the actual import sequentially.

In accordance with other aspects of the present disclosure, the system 100 may be configured to automatically import CSV documents via a shared folder. A scheduled job may be responsible for notifying the system 100 to scan the shared folder. In one implementation, the job may run every day between 10h00 and 22h00 at an interval of 30 minutes. For example, an admin user copies a CSV file to a shared folder. The scheduled job then sends a request to the computing server system 110 to check whether any file needs to be imported or not. If a file is found, an import is invoked. If the import succeeds, then the file is moved to the success folder. If the import fails, the file is moved to the failed folder. <CSVFileName>.errors.txt and a log file may be created in the failed folder and contains the errors. Importing tasking does not immediately import the content, the computing server system 110 may scan for any pending upload and perform the import sequentially.

Some tasks delivered through the system 100 may require a user to contact specific patients to complete the tasks. Because patients may be located in multiple time zones, the system 100 may require the ability to flag a task as time zone sensitive such that patients are not contacted outside of allowable call hours. The series of area codes mapping its corresponding time zone ID is available via the application setting areaTimeZones. As shown in FIG. 5, a TimeZoneFilter 502 from a CSV upload may indicate if a task is time zone sensitive or not. When TimeZoneFilter=Y, the ZipCode value is required, where ZipCode=patient's mailing address zip code. The ZipCode may be used to determine a patient's Time Zone 504. Time Zone may be used to determine the callable hours for that address. If no zip code is available, or if the zip code provided does not return a time zone, a ContactPhone area code may return a time zone. In situations where a zip code nor an area code returns a time zone, the system 100 may utilize default call hours (if setting value is set) 508. In situations where a zip code returns multiple time zones, the later (furthest from UTC) time zone may be used 510.

For example, when tasks are imported, the time zone may be calculated based on either the zip code or the area code of the phone number. The supported formats for a zip code is <5 digits>, e.g., 27519; or <5 digits>-<extension>, e.g., 27519-9499. The series of area codes mapping its corresponding time zone ID is available via the application setting zipCodeTimeZones. When tasks are imported, the time zone is calculated based on either the zip code or the area code of the phone number. The series of area codes mapping its corresponding time zone ID is available via the application setting areaTimeZones. In some embodiments, for each identified time zone, the callable hours may start from 8 AM to 8 PM or any selected period of time. To provide flexibility during Daylights Savings Time, the callable hours may be a configurable value that can be updated by the system 100, if needed.

When a time zone filter (e.g., TimeZoneFilter 502) is enabled for a task, the callable hours may be calculated by the computing server system 110 based on the following rules 512. If the zip code is specified, the computing server system 110 may retrieve its corresponding time zone from the dictionary. If the contact phone number is specified, then the computing server system 110 extracts the area code, and retrieves its corresponding time zone from the dictionary. Then the computing server system 110 uses the patient callable hours (setting patientCallableHours) (e.g., 08:00-20:00) and convert it into UTC using the time zone from prior rules and assign the task 514. If the time zone cannot be determined, then the default callable hours (setting defaultCallableHours), which may be set in EST, may be used converted into UTC. In some embodiments, the computing server system 110 may not assign the task and evaluate the next highest priority task in response to detecting that the current time does not correspond to callable hours 516. For an imported task, if the time zone filter is enabled, then callable hours (calculated using the above rules) may be converted to UTC. For example, if the callable hours are 08:00-20:00 and the calculated time zone is America/Chicago (CST-05:00), that means the task's callable hours will be 11:00-01:00. If the time zone filter is disabled, then no callable hours will be saved with the task.

A disposition spec may be used by the computing server system 110 to categorize the reason for completing/closing a task. Dispositions specs may be created and managed by administrators. Disposition specs can be created via an UI of the system 100 or imported via a CSV document. A disposition spec may be assigned to a task during the CSV upload and displayed to a user as drop-down options when completing a task. In one example, a disposition spec may include a three-level hierarchy: outcome (required): 1-many; reason (optional): 1-many; detail (optional): 1-many. A disposition spec can be made up of the following: outcome; or outcome+reason; or outcome+reason+detail. The disposition spec is displayed to users when they complete a task in the form of drop-downs. A drop-down list may be presented for each level of the disposition. When displaying the disposition options to an end user upon completion of a task, only the levels that exist in the disposition spec are displayed. For example, if a disposition spec contains only two levels (Outcome+Reason), then Detail may not be displayed as an option to the user to select.

Certain task types may require group or batch tasks together for efficiency. For example, to verify insurance with a payer, it is efficient to batch all the relevant patients together. Batch tasks may not replace the original task and may be an additional option when creating a task. Task types can be added via an UI of the system 100 or via a task type import. A series of tasks grouped together may become children of a virtual parent task. A parent task may not be completed directly by the user. When the last remaining child task is completed, the parent task may be automatically completed.

In one aspect, the computing server system 110 may use a number of properties of a task type to determine how to group tasks together. The name (property: taskTypeName) of a task type may be the identifier of the task type. This value may be used to group tasks in a CSV file, and it is the value to use for TaskType CSV column. A display name (property: task Type DisplayName) may be used as the parent task's title. The property “groupByProperty” is one of the header names defined in the Task CSV Import. The property “groupByDisplayName” may be used as the parent task's description.

During a task import, tasks may be grouped together if a task type is specified. If the task queue is different, the tasks may be grouped within their owning task queue. If the task type is not specified, then the task may not be grouped with any other task, it may remain a standalone task. In some embodiments, the grouping of tasks may only occur during a single task import process. That is, tasks may not be grouped with existing tasks or tasks from another CSV document that is being imported. There may be no limits for how many tasks can be grouped together. A task type may define which property will be used to group task together. A task definition in the CSV file may specify the task type name.

To regroup tasks together, a parent task may be created and may serve as a container. The parent task may have the following information: the name may be the task type display name; the description may be the group by display name; the alternate description 1 may be the group by property name; the alternate description 2 may be the property's value; the priority may be the highest child task priority; and the persistent flag may be true if at least one child task is persistent.

In some embodiments, if a parent task is not auto-completable by itself, it will get automatically completed/closed when the last active child task is completed/closed. All active tasks may be abandoned when the group is not completed. As a result, another user will be able to work on the remaining tasks.

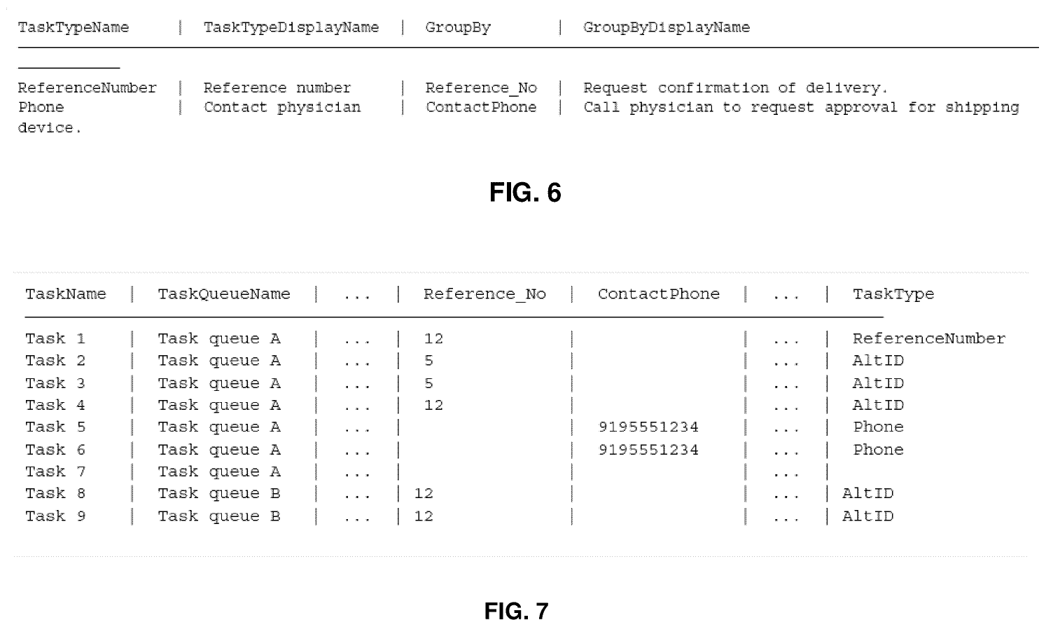

In accordance with certain aspects, FIG. 6 shows a number of different task types. FIG. 7 shows that tasks 1 and 4 will be grouped together. The task type and the group by property are the same, they are grouped together and not with 2, 3 (different property value) and 8, 9 (different task queue). Tasks 2 and 3 will be grouped together. Since the task type and the group by property are the same, tasks 2 and 3 are grouped together and not with 1, 4 (different property value) and 8, 9 (different task queue). Next, tasks 5 and 6 will be grouped together. Both the task type and the group by property match. Task 7 will not be grouped because no type was specified. Task 8 and 9 will be grouped together because they are for another task queue.

That is, a parent task may be created to regroup tasks 1 and 4 based on name: reference number; description: request confirmation of delivery; alternateDescription1: AltID; and alternateDescription2: 12. A parent task may be created to regroup tasks 2 and 3 based on: name: reference number; description: request confirmation of delivery; alternateDescription1: AltID; and alternateDescription2: 5. Further, a parent task may be created to regroup tasks 5 and 6 based on: name: contact physician; description: call physician to request approval for shipping device; alternateDescription1: phone; and alternateDescription2: 9195551234. Additionally, a parent task may be created to regroup tasks 8 and 9 based on: name: reference number; description: request confirmation of delivery; alternateDescription1: AltID; alternateDescription2: 12.

In accordance with aspects of the present disclosure, a parent task may be used as the task to be found when requesting the next available task. Upon assignment, all child tasks are also assigned to a user. The parent and child tasks may have their start and trigger times set. When one child task is completed, its completed time and disposition will be set. The remaining active child tasks may have their start and triggered times updated based on the now closed child task's completed time. As a result, the computing server system 110 may determine the elapsed time taken to complete each child task. The parent task's triggered time may be updated with the child task's completed time. When the last active child task is completed, the parent task may automatically be completed as well. A task timeout may work the same as for a standalone task. The task timeout may be based on the parent task's triggered time. If a batch task is found to have been abandoned, all incomplete child tasks may be released, and all complete child tasks may not be modified. As such, the parent and incomplete child tasks may be available for another user to work on the remaining child tasks.

The application of the present disclosure supports application-level properties. In one embodiment, certain settings may not be defined in app.conf, but are stored in a database table of the computing server system 110 as key/value pairs. The type of the value may be an integer, a decimal, a Boolean (true or false), or a JSON object/array. Some example built-in application settings may include task timeout, task timeout buffer, task abandon timeout, area time zones, automate task queue cleaning, callable hours, default callable hours and pausable tasks.

Specifically, with respect to the property of “taskTimeout,” the computing server system 110 may determine a certain amount of time for a user to work on a task. This function determines the length of time a user has to work on a task before a notification is generated. The unit of this property is minute. In one embodiment, a default allowed period of time for a user to work on a task may be 15 minutes.

When the allowed amount of time has been reached, the user has a short amount of time to inform the system she is still working on the task. In one example, the computing server system 110 may set up a “taskTimeoutBuffer” to define the length of time a user has to notify the system 100 that she is still working on the task. A notification may be generated and displayed to the user. The unit of this property may be second, according to one embodiment. For example, a default amount of time the user has to notify the system 100 she is still working on the task may be 30 seconds. In some implementations, during this time, the computing server system 110 may display a browser to the foreground of the user's monitor, which may generate a notification sound and run a countdown sound, ending with an ending alert sound, after which the task may be abandoned, and the user may be placed in the off-queue state.

Task abandon timeout refers to the amount of time that is used by a scheduler module of the computing server system 110 as an amount of time past the task TimeoutBuffer before to automatically un-assigning the user from the task. The unit of this property may be second. The default amount of time the computing server system 110 may wait before automatically un-assigning the user from the task may be 30 seconds, according to one embodiment.

When the computing server system 110 sets “automateTaskQueueCleaning” to be true, non-persistent tasks uploaded on a prior date may be archived upon each import. The default value of this property is false.

As discussed above, the property of “patientCallableHours” may have a default value set to 0800-2000 (8AM-8PM). The values may use 24h format and may be used in accordance with local time. If the setting is set to 0800-2000 (8AM-8PM), the task may only be served to an agent if the current time is currently within that range for the time zone associated with the task. For example, if the callable hours calculation by the computing server system 110 determines that the task's time zone is Pacific Time, the task's callable hours are 8h00 to 20h00 PST. If the time zone is Eastern Time, the task's callable hours are 8h00 to 20h00 EST.

Further, the computing server system 110 may set “defaultCallableHours” to a default value of 0800-2000 (8PM-8PM). This value is always used in Eastern Time and are always using 24h format. If the callable hours may not be determined based on the zip code or area code, and the task does not use a time zone filtering (taskTimeoutBuffer is false), this value may be used by the computing server system 110 when determining the task's callable hours.

In addition, “pausableTimeout” may refer to amount of time a primary task can be paused while a user works on side tasks. Once the amount of time is reached, the task may be determined by the computing server system 110 as being abandoned and will be automatically released. For example, the unit of this property may be minute and a default timeout may be 30 minutes.

During a CSV import process, upload history records may be created for each uploaded file. If a user closes out of the browser or loses connection before seeing the CSV import results, viewing the upload history may allow the user to check the results of the upload. Upload history records are created for each individual file uploaded. The properties of upload history may include a created date (time that CSV was loaded into system); created by (user who uploaded the CSV into the system); file name; file data (CSV contents); results (errors from the import process); and upload key which is a unique value generated by the computing server system 110 for linking an upload to the tasks that was created.

In some embodiments, importing a significant set of tasks into the system 100 may be time consuming. In order to provide a feedback of the progress, a task import may be carried out asynchronously. A UI of the system 100 may be configured to display a progress of a CSV file being imported. For example, the computing server system 110 may be configured to provide a percentage of completion from 0% to 100%.

In accordance with additional aspects of the present disclosure, a skill group may group a subset of users of the system 100. Users associated with a skill group may be assigned tasks from the task queue(s) that their skill group is assigned to. A skill group can have 0 or many task queues. Users can be assigned to many skill groups. In one embodiment, users may be assigned to skill groups within the application by supervisors or admins. Skill groups are fluid and may be edited to assign or remove users as needed by supervisors or admins. In one aspect, a skill group may include a name, be associated with a department and can be active or inactive.

An on/off queue represents the ability for a user assigned to a skill group to work on tasks or not. When a user is added to a skill group, the user may not be added to a queue by default. When the user is active, it means the user is on the queue and ready to work on another task after completing the current task. When the user is inactive, it means the user may not be automatically assigned a new task after completing the current task. It is the responsibility of the user to add herself to the queue. By doing so, it means she is ready to take on or work on tasks. When the user can no longer work on tasks, she must change her status by removing herself from the queue. When a user is ready to work on a task, she will request a task and the application may automatically assign the next available task. In some embodiments, the computing server system 110 may be configured to allow supervisors or administrators to remove a user from a queue.

When requesting to work on a task, the application of the system 100 may be configured to determine which task the user can work on. If the user was inactive (off queue), the user's status may be updated to be active (on queue). A task may be updated with the following data: the start and triggered times will be set to now; the user ID will be set to the user's ID; the status will be set to ACTIVE; and if the task is a parent task (created to group batch tasks together), then the above will be applied to all child tasks.

In one aspect, a plurality of rules may be set by the computing server system 110 to determine the next available task a user can work on. For example, skill groups with which the user is associated must be active. The task queues that are children of the skill group with which the user is associated must be active. The tasks must be available and open to be worked on (i.e., not canceled, active, or completed). The tasks must not be child tasks (i.e., assignment is derived from the parent task when tasks are grouped for batch task), the parent task is used as a primary task to assign to the user. All tasks created today are all possible candidates, for tasks created in the past, they must be persistent. The time of requesting a task must be within the task's callable hours. The available tasks are sorted in an ascending order using the task queue's priority from the most important to the least important. Within each task queue, the tasks are sorted in a descending order using the task's priority from the most important to the least important.

To create a skill group, the computing server system 110 may require inputs such as a skill group name, a skill group department which is a user created value and does not come from Active Directory (Link), and skill group users. Skill groups can be edited after they are created. For example, the computing server system 110 may be configured to edit a skill group name, a skill group department, and skill group users (add and/or remove).

A task queue or campaign may be a container of tasks. It can be active or inactive. A task queue may be assigned a priority and its priority can be updated. Task queues may be displayed on the task queue manager screen. Task queues are worked by a user associated with the owning skill group. A task queue can only have one owning skill group.

In one aspect, a task queue summary may be configured to provide details of a task queue itself and the state of all of its tasks. For example, a summary may include the following information: the task queue itself; a skill group (name and department); users including an active user count (the number of active users associated with the owning skill group) and a total user count (the number of active and inactive users associated with the owning skill group). The summary may also include information regarding tasks such as a total count (the number of tasks owned by the task queue, regardless of the task status), an active count (the number of tasks owned by the task queue that are currently assigned to users), a canceled count (the number of tasks owned by the task queue that have been canceled by an admin), a completed count (the number of tasks owned by the task queue that have been completed by users), an incomplete count (the number of tasks owned by the task queue that are currently assigned to users or are ready to be worked on), and an open count (the number of tasks owned by the task queue that are ready to be worked on (i.e., not assigned to a user). Batch tasks (tasks grouped together) have a parent task and these parent tasks are not part of the calculation in the summary. Further, all the counts may be determined based on the tasks that are created in the past and are persistent.

In some embodiments, the system 100 may be configured to filter task queues via, e.g., SQL queries (SELECT/FROM and WHERE clauses). For example, task queues created today may be included. When a task queue reaches 0 active task for the day, the task queue should remain visible and show 0/xxx tasks remaining. On the following day, prior to any data load, when no tasks are persisted and there are O active task for today the task queue should not be visible. That is, a task queue is visible if created today or if there are tasks created today, or there are persistent tasks (i.e., created in the past of today's date), or active tasks. Each task queue has a priority. The priority starts at 0 and the maximum allowed is 999999999. The lowest the number, the highest the priority. The priority may be used when determining the next available task. Task queues may be primarily created by specifying the task queue name within the Task CSV document. In some embodiments, while a UI of the system 100 may not provide the ability to create a new task queue, the API gateway device 112 may be configured to create a new task queue. A task queue may be edited via the UI or the API. Example editable properties may include a name, a description, an active flag, and a priority. In an aspect, an empty task queue process may be used to archive non-persistent tasks, which means the tasks may no longer be workable once they are archived. The auto-empty of task queues may run by default, but can be turned off using an application setting. For example, a persistent flag may determine whether old tasks should be kept (not archived) or should be archived. If the persistent flag is set to true, the task is never archived, but the task queue itself may not be changed. Before an import process is invoked, the computing server system 110 may check the application setting to determine whether the process should run or not and check whether at least one task was created today or not. If there is at least one task created today, the empty task queue will not run. If there are no tasks created today, the empty task queue will run and the import process will commence.

In accordance with further aspects of the present disclosure, a task represents a unit of work that will be assigned to users belonging to the same skill group. It can be assigned to a user if and only if it is unassigned and available. Example properties of a task may include a name (type: string) which may be displayed to the user when actively working on a task, and a description (type: string) which includes descriptive information about a task that is displayed to the user when actively working on a task. Each task is assigned a priority (type: integer). Higher priority values mean higher priority. A task also includes a start date (type: string for date in ISO-8601 format using Zulu time zone) which is the date/time the user started to work on the task, and a trigger date (type: string for date in ISO-8601 format using Zulu time zone) which is the date/time the user starts to work on the task or the date/time the user acknowledges the timeout warning and indicates that she is still working on the task. A task also has a complete date (type: string for date in ISO-8601 format using Zulu time zone) which is the date/time when the user has completed the task. Further, a task status (type: string) determines the state of the task in its life cycle.

The computing server system 110 may generate a section on a task screen to give a user detailed instructions for completing an assigned task. This function also facilitates departments cross train employees on how to handle different tasks by providing detailed instructions directly on the task screen. Task details are defined in the CSV upload (column TaskDescription). To make the task instructions section easier to read for a user, various formatting may be used such as bold, italic, underline, unordered list (bullet points), ordered list, line breaks, and hyperlinked text.

Tasks may include a plurality of status indicators. For example, a task is open when the task is available to be worked on and it is currently not assigned to a user. When a user is assigned a task, the task's status changes from open to active. For batch task, the parent and child tasks may be assigned to a user and their status may be changed to active. If a task is canceled, it should no longer be worked and no user can be assigned the task. In some embodiments, the API gateway device 112 of the system 100 may support canceling a task. When a user completes the task currently assigned to her, she completes the task by specifying the disposition. Once completed, a task cannot be worked on again. When a task needs to be archived, it may first be soft deleted during an archiving process, then it may be deleted. In one embodiment, the frontend of the system 100 may never receive tasks with this status (i.e., DELETED), thereby preventing a database locking due to the foreign key constraint on the task queue.

In some examples, in response to detecting that a user is taking a long time to complete a task, the computing server system 110 may generate a notification. The user may have a predefined length of time to indicate that she is still working on the task. The task timeout may serve two purposes: hold users accountable by notifying them that their task is taking a long time to complete, and ensure that no tasks are left orphaned in cases where a user forgot to go off queue at the end of a shift or before taking a break. The warning is presented to a user every time the allowed time is reached and until the task is completed. The task timeout warning may be configured by an admin and displayed in a way to most likely alert a user. If a task is still assigned to the user, and the task timer continues to increment up. The timeout timer may be reset to zero but not be displayed to the user in the UI. If the user does not complete the task by the time the timeout value is reached again, the timeout warning may be generated and displayed. According to one embodiment, there may be no limit on the number of times the task timeout warning can be displayed. In response to detecting that a user does not acknowledge the timeout warning, the computing server system 110 may return the task to the task queue, such that it can be reassigned to another user based on the task queue and task priority. No changes may be made to the task when returning it to the queue and the existing task priority is maintained. The user may be taken off queue and returned to the User Landing page, as shown in FIG. 3B.

A task may be auto-released if the maximum length of time has been reached; or the allowed time to notify the system 100 the task is still being worked on has been reached; or the buffer time used by the computing server system 110 to wait until the allowed time to notify the user has been reached. As a result, the task may be abandoned. The computing server system 110 may scan all active tasks and if any tasks are in an abandon state, the user may be unassigned and the status may be changed from ACTIVE to OPEN in order to be worked on again. In one embodiment, the computing server system 110 may configure auto-release based on: (task.triggeredOn (date/time)+taskTimeout (minutes)+taskTimeoutBuffer (seconds)+task AbandonBuffer (seconds))>now (date/time). A background process by the computing server system 110 may scan all active scans, perform the calculation and automatically un-assign the user from the task and take the user off queue.

A task life cycle starts when a task of the system 100 is created by importing a CSV document via the UI or from the shared folder. Single tasks and batch tasks (parent task with child tasks) are all created with their status set to “open.” In some examples, if the next available task is a batch task, the parent task and all child tasks may be assigned to the user. Once a task is assigned to a user, a countdown starts. If the countdown reaches zero, i.e., the task times out, a user may be automatically unassigned from the task and the task's status is changed from “active” to “open.” This means the task is returned to the queue and the user is taken off the queue, and the user is not assigned another task. For a batch task, all the active child tasks and the parent task may be returned to the queue. Completed child tasks may not be changed. Once a task is completed, its status cannot change. The user may complete the task by selecting the appropriate disposition from the predefined series of dispositions. All tasks that are active are always visible, meaning any user passing the set of rules, can be assigned to available tasks. If a single task is pausable, its status may be set to “paused.” The system may not pause a batch task (parent or any child task). When a user pauses a task, she may be presented with another task. The tasks that can be worked on while the current task is paused must have been set as “side task.” Once the side task is completed, the user may be redirected to continue to work on the task that was paused, or work on another side task. In one implementation, the duration of a paused task may be 30 minutes or any selected period of time. After that time, the task may be abandoned and will be released.

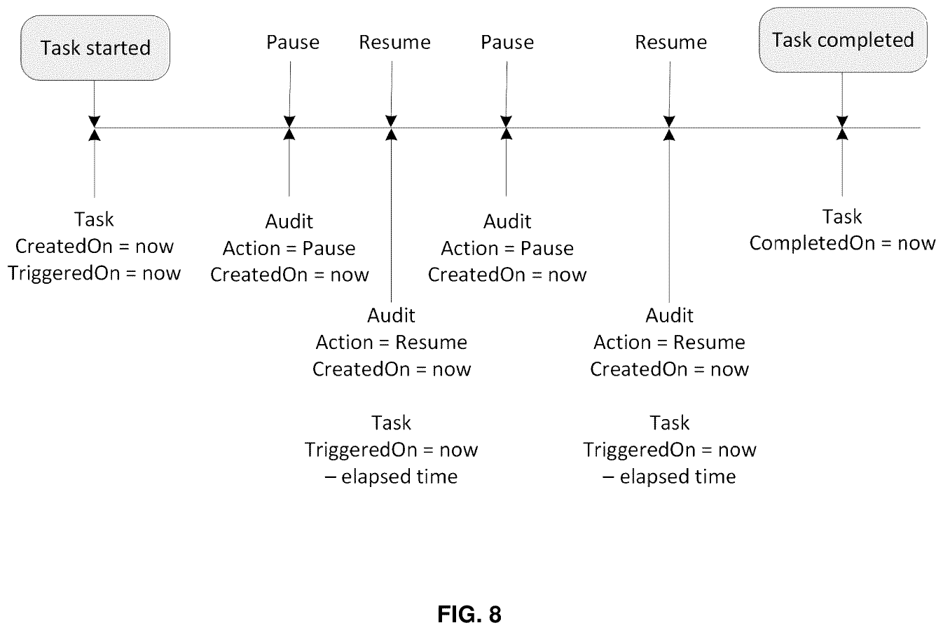

The completion time of a task is the time it took a user to work on a task, which is also referred to as elapsed time. For a single task that is never paused, the calculation is based on: completion time=completedOn−startedOn. For a batch task, the calculation of completion time for each child task may use the same formula. To get the child tasks to use the same formula than a single task, referring to FIG. 8, the computing server system 110 may determine that a parent task has its startedOn and triggeredOn set to now, and all child tasks have their startedOn and triggeredOn set to now. Upon completion of a child task, the completed child task has its completedOn set to now, the parent task has its triggered set using the completed task's completedOn, and the remaining active child tasks have their startedOn and triggeredOn set using the completed task's completedOn. Upon completion of the last active child task, the completed child task has its completedOn set to now, the parent task has its triggeredOn set using the completed task's completedOn, and the parent task has its completedOn set to now. The parent task is also automatically closed. For a task that was paused, the computing server system 110 may determine the completion time=(completedOn−audit/resumen)+ (audit/pauseᵢ−audit/resumeᵢ₋₁)+ (audit/pause₁−startedOn). The audits may be sorted in a descending order (from newest to oldest) where n means the newest audit, and i and (i−1) in the summation means the audit at a given index and the audit at index-1 (i.e., the audit that is older than the audit at the given index). For the UI to display the correct elapsed time, the task triggered date/time may be adjusted based on how much time was spent on the task already: triggeredOn=now−elapsed time.

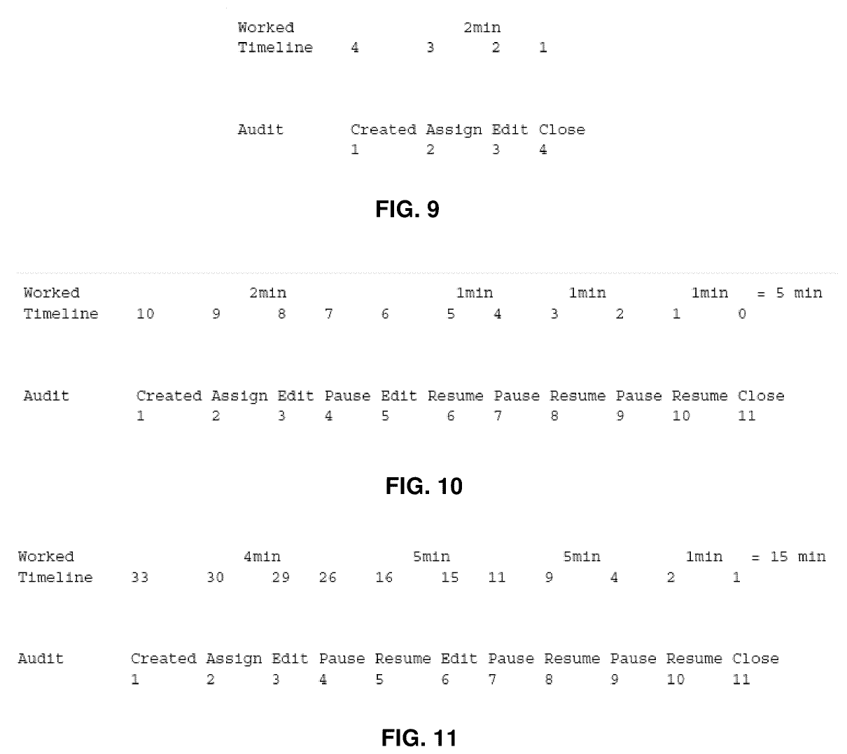

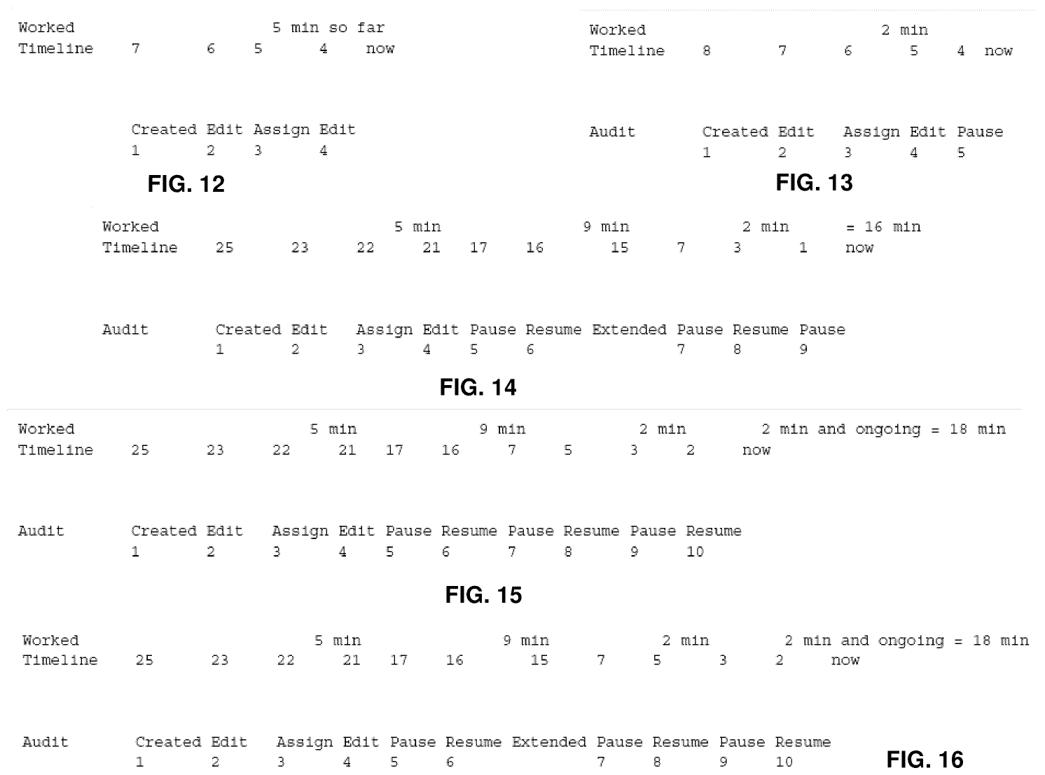

The following series of examples show how the elapsed time may be calculated by the computing server system 110 and how it may affect the triggered time. A task may be completed without any pause. As shown in FIG. 9, a triggered time is not modified and the elapsed time is 2 minutes. A task may be completed with pause but without extension. As shown in FIG. 10, a triggered time is not modified and the elapsed time is 5 minutes. A task may be completed with pause and with extension. As shown in FIG. 11, a user requested more time when the timeout has reached. The triggered time is not modified and the elapsed time is 15 minutes. A task may be active without pause and without extension. As shown in FIG. 12, the triggered time is not modified and the elapsed time is 5 minutes. Further, a task may be active with pause, still paused, and without extension. As shown in FIG. 13, the triggered time is not modified and the elapsed time is 2 minutes. A task may be active with pause, still paused, and with extension. As shown in FIG. 14, the triggered time is not modified and the elapsed time is 16 minutes. A task may also be active with pause, was resumed, and without extension. As shown in FIG. 15, the triggered time was adjusted and 4 minutes was added to it. The task was paused at 17 to 16, 7 to 5, and 3 to 2, thus 1+2+1 minutes need to be added. The elapsed time is 18 minutes. In yet another example, a task may be active with pause, was resumed, and with extension. As shown in FIG. 16, the triggered time was adjusted and 3 minutes was added to it. The task was paused at 7 to 5 and 3 to 2, thus 2+1 minutes need to be added. The elapsed time is 18 minutes.

In certain embodiments, a task may be created/added via a task import process. A task may not be editable except for pausing the current task if it is a single task, resuming a paused task, the user notifies the computing server system 110 that she is still working on the task after the timeout was reached, or to cancel it. A batch task may not be paused. The computing server system 110 may be configured to edit the name and description of a task.

An active task may be closed, i.e., completed, by an assigned user. Once the task is closed, it cannot be re-opened. When closing a task, a disposition must be specified. The outcome, reason, and detail may be specified by an assigned user from the options available within the disposition spec associated with the task. A task disposition is a multi-level, predefined outcome of a task, displayed to and selected by a user during the task completion function. In one embodiment, task dispositions may be created or modified by admins or supervisors of the system 100. Task dispositions cannot be deleted. A task is marked completed when its task disposition is received. In some examples, a task disposition may be a tree-like structure including a plurality of task disposition options and displayed as cascading combo boxes in the UI of the system 100. The primary ID of a disposition spec is the outcome, which is a string.

Archived tasks may represent tasks which are no longer available in a task queue. Archived tasks also use the same properties as normal tasks, except that an archived task cannot be altered and contains all of the normal task's properties at the time when it was archived.

Departments exist in two contexts in the system 100: a user's department and a department a skill group belongs to. These two separate lists of departments in the system 100 may mirror one another but they do not have to match. A user's department may generally refers to the active directory department of a given user. This value is displayed in the Skill Group screen and is to be used to help supervisors filter user lists when assigning users to skill groups. The relationship between departments and skill groups is one department to many skill groups. Skill groups may only be assigned to one department. Skill group department is semantic data used for organization/filtering between skill groups, departments, and task queues.

As discussed above, users of the system 100 may have a fixed amount of time to work on their assigned tasks. If the time runs out, each user can request additional time. In order for abandoned tasks to be released and worked on by another user, they must first be unassigned. In some embodiments, the computing server system 110 may be configured to have a background process that scans all assigned tasks and determines whether the tasks are abandoned or not. If a task is abandoned, the computing server system 110 un-assigns the user from it.

In some alternate embodiments, the computing server system 110 may be configured to include an animation to a task timer, so that when the timer surpasses a pre-set value it alerts users that they are taking a long time to complete the task. Some example animations may include turning the font of certain texts red and shaking the timer. The system 100 may also define the time at which the animation should occur in the CSV upload as an optional field.

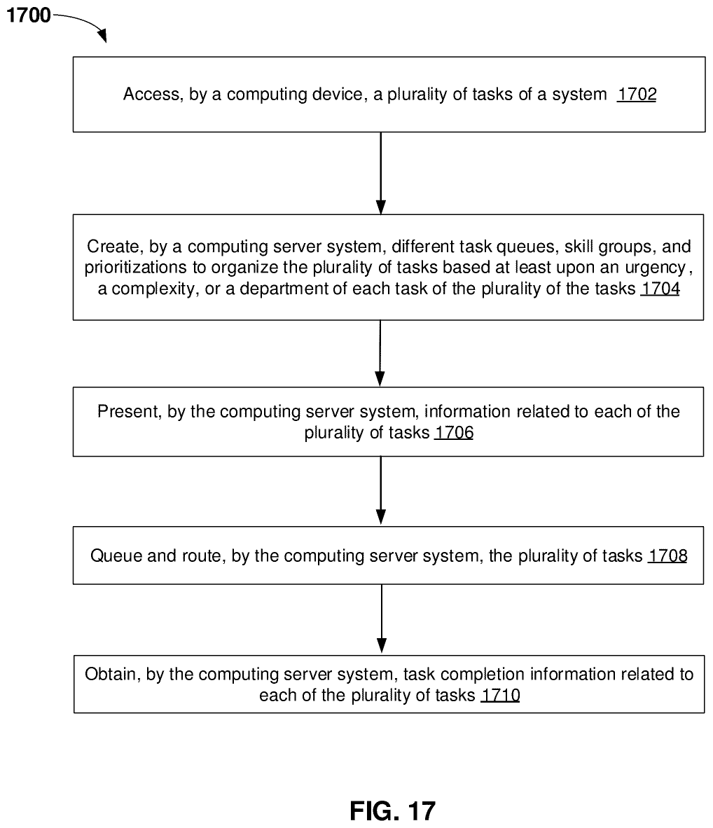

According to aspects of the present disclosure, FIG. 17 illustrates a flowchart of a method 1700 for managing a plurality of tasks of a system. Method 1700 may comprise accessing (1702), by a computing device deployed within a communication network, a plurality of tasks of the system. The method 1700 further comprises creating (1704), by a computing server system deployed within the communication network, different task queues, skill groups, and prioritizations to organize the plurality of tasks based at least upon an urgency, a complexity, or a department of each task of the plurality of the tasks. The method 1700 additionally comprises presenting (1706), by the computing server system, information related to each of the plurality of tasks, queuing and routing (1708) the plurality of tasks, and obtaining (1710) task completion information related to each of the plurality of tasks.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system, comprising:
a computing device, comprising:
a non-transitory computer-readable storage medium configured to store an application program; and
a processor coupled to the non-transitory computer-readable storage medium and configured to control a plurality of modules to execute instructions of the application program for accessing a plurality of tasks of the system; and
a computing server system configured to:
create different task queues, skill groups, and prioritizations to organize the plurality of tasks based at least upon an urgency, a complexity, or a department of each task of the plurality of the tasks,
present information related to each of the plurality of tasks,
queue and route the plurality of tasks, and
obtain task completion information related to each of the plurality of tasks.

2. The system of claim 1, wherein the computing device is used by a first user of the system to access the plurality of tasks in order to receive an assignment of one of the plurality of tasks, wherein the first user is associated with at least one of the skill groups.

3. The system of claim 2, wherein the computing server system is configured to assign the one of the plurality of tasks to the first user based at least on an indicia of whether the first user is active or inactive.

4. The system of claim 3, wherein the computing server system is configured to assign the one of the plurality of tasks to the first user in response to determining that the at least one of skill groups with which the first user is associated is active, the task queues that are children of the at least one of skill groups with which the first user is associated is active, the one of the plurality of tasks is available and open to be worked on, and one of the plurality of tasks is not a child task, and a parent task is used as a primary task to assign to the first user, wherein a time of requesting the one of the plurality of tasks by the first user is within the task's callable hours.

5. The system of claim 4, wherein the computing server system is configured to sort the plurality of tasks in an ascending order based on a task queue's priority from the most important to the least important, and within each task queue, sort tasks in a descending order based on each task's priority from the most important to the least important.

6. The system of claim 2, where the computing device is used by a second user of the system to access the plurality of tasks in order to assign or remove the first user from the at least one of the skill groups, wherein the second user includes at least one of a supervisor or an admin of the system.

7. The system of claim 2, wherein the computing server system is configured to create the different task queues, skill groups, and prioritizations by importing at least one of: one or more comma-separated values (CSV) documents, one or more computing systems connected with the computing server system, and one or more application programming interface (API) calls of the computing server system.

8. The system of claim 7, wherein the computing server system is configured to capture execution metrics of the plurality of tasks performed by users and the one or more computing systems, wherein the execution metrics include a task duration and a task outcome.

9. The system of claim 7, wherein the computing server system is configured to import each of the one or more CSV documents via a user interface of the system or via a shared folder of the system.

10. The system of claim 9, wherein the one or more CSV documents of a series of task queues and tasks to be imported specify a task queue name, a skill group name, a disposition specification name, a task name, a task description, and a priority of each task.

11. The system of claim 10, wherein each of the one or more CSV documents includes an indicia of whether a task is time zone sensitive.

12. The system of claim 11, wherein the computing server system is configured to determine a time zone based on a zip code or an area code of a phone number indicated in each of the one or more CSV documents.

13. The system of claim 7, wherein each of the one or more CSV documents include a disposition specification for categorizing an outcome for completing and closing a task by the first user, wherein the disposition specification comprises a reason and details of the task.

14. The system of claim 3, wherein the computing server system is configured to generate and display a notification to the first user via the application program in response to detecting that the one of the plurality of tasks assigned to the first user has not been completed within a predefined length of time.

15. The system of claim 14, wherein the computing server system is configured to control a timer after the predefined length of time and generate an alert to the first user via the application program to allow the first user to acknowledge the alert.

16. The system of claim 15, wherein the computing server system is configured to return the one of the plurality of tasks assigned to the first user to a task queue by maintaining a priority of the one of the plurality of tasks in response to detecting that first user fails to acknowledge the alert after the timer has reached a timeout value.

17. The system of claim 3, wherein the computing server system is configured to pause the one of the plurality of tasks assigned to the first user.

18. The system of claim 10, wherein the task description includes detailed instructions for completing an assigned task.

19. A computer-implemented method, comprising:
accessing, by a computing device deployed within a communication network, a plurality of tasks of a system;
creating, by a computing server system deployed within the communication network, different task queues, skill groups, and prioritizations to organize the plurality of tasks based at least upon an urgency, a complexity, or a department of each task of the plurality of the tasks;
presenting, by the computing server system, information related to each of the plurality of tasks;
queuing and routing, by the computing server system, the plurality of tasks; and
obtaining, by the computing server system, task completion information related to each of the plurality of tasks.

20. A non-transitory computer readable medium storing computer executable instructions for a system deployed within a communication network, the instructions being configured for:
accessing, by a computing device, a plurality of tasks of the system;
creating, by a computing server system, different task queues, skill groups, and prioritizations to organize the plurality of tasks based at least upon an urgency, a complexity, or a department of each task of the plurality of the tasks;
presenting, by the computing server system, information related to each of the plurality of tasks;
queuing and routing, by the computing server system, the plurality of tasks; and
obtaining, by the computing server system, task completion information related to each of the plurality of tasks.
